(19) United States
(12) Patent Application Publication
(10) Pub. No.: US 2006/0061614 A1
(43) Pub. Date: Mar. 23, 2006

(54) Image processing apparatus

(75) Inventors: Mari Kodama, Kanagawa (JP); Yoshiharu Hibi, Kanagawa (JP); Ryuichi Ishizuka, Kanagawa (JP); Toshifumi Takahira, Kanagawa (JP); Masaomi Sakamoto, Kanagawa (JP); Yasushi Nishide, Kanagawa (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/022,836

(22) Filed: Dec. 28, 2004

(30) Foreign Application Priority Data
Sep. 22, 2004 (JP) 2004-274821

(51) Int. Cl. B41J 29/393

(52) U.S. Cl. 347/19

(57) ABSTRACT

An image processing apparatus has an operating section and a control section. The operating section operates a control section, and the operating section is operated by a user. The control section calculates estimated quantity of ink for each color used for printing an image expressed by image data and notifies a user of information that a total of the calculated estimated quantity of ink for each color exceeds predetermined quantity.

### BACKGROUND OF THE INVENTION

1. Field of the Invention

The present invention relates to an image processing apparatus used for editing image data.

2. Description of the Related Art

In recent color printing, densities of ink dots of four colors; that is, cyan (C), magenta (M), yellow (Y), and black (K), are changed to thus approximately express various colors. If there is an area where the respective ink densities assume 100%, ink of all colors; i.e., CMYK, is applied in the quantity of 100% for each color. In short, 400% of ink is applied. However, when the quantity of ink has exceeded a certain level (threshold value), there has been known to arise a phenomenon where ink fails to stick to paper and returns to a printing machine (reverse trapping), or a setoff phenomenon where ink soaks through from the front of paper to the back of the same, to thus soil the back of the paper. Although the threshold value is determined from various conditions; that is, the type of a printing machine, the type of paper and a printing speed, the threshold value is usually determined to fall within the neighborhood of 300%.

In recent years, a printing document is prepared from electronic image data. Such print data mixedly include line data, such as an illustration or characters, and image (bitmap) data typified by a photograph. Print data can be prepared by means of appropriately laying out the print data through use of software having a layout function. The print data are output by means of a color printer, and the result of output is then subjected to data correction and color correction.

However, when printed matter is output for proofing by means of a color printer, the output is produced after color correction or toner limitations have been performed in consideration of characteristics of the color printer. For this reason, the density of actual data is corrected, and hence there arises a case where, even when data includes ink densities exceeding those which would pose a problem during printing, this fact is not noticed.

### SUMMARY OF THE INVENTION

The present invention has been made in view of the above circumstances and provides an image processing apparatus capable of reporting the quantity of ink during printing.

According to an embodiment of the present invention, there is provided an image processing apparatus. The image processing apparatus includes an operating section and a control section. The operating section operates a control section, and the operating section is operated by a user. The control section calculates estimated quantity of ink for each color used for printing an image expressed by image data and notifies a user of information that a total of the calculated estimated quantity of ink for each color exceeds predetermined quantity.

### BRIEF DESCRIPTION OF THE DRAWINGS

Embodiments of the present invention will be described in detail based on the following figures, wherein: FIG. 1 is a block diagram showing an example configuration of an image processing apparatus according to an embodiment of the present invention; and

FIG. 2 is a descriptive view showing an example area database used for specifying a draw area on a per-object basis.

### DETAILED DESCRIPTION OF THE EMBODIMENTS

An embodiment of the present invention will be described by reference to the drawings. As shown in FIG. 1, an image processing apparatus includes a control section 11, a storage section 12, an operation section 13, a display section 14, and an interface section 15.

The control section 11 is a CPU or the like and operates in accordance with a program stored in the storage section 12. The control section 11 of the present embodiment calculates, on the basis of image data which are objects of processing, estimated quantity of ink for each color used for printing an image expressed by image data. When the total of calculated, estimated quantity of ink for each color has exceeded a predetermined quantity, a report to this effect is provided. Operation of this control section 11 will be described in detail later.

The storage section 12 includes a storage element, such as RAM (Random Access Memory), a hard disk drive, and a computer-readable recording medium. This storage section 12 stores a program to be executed by the control section 11. This storage section 12 also serves as work memory for retaining various data sets required for operation of the control section 11.

The operation section 13 is a mouse, a keyboard, or the like, and outputs details of instruction operation to the control section 11 upon receipt of the user's instruction operation. The display section 14 is a display or the like and provides information in accordance with an instruction input by way of the control section 11. The interface section 15 is, e.g., a USB (Universal Serial Bus) or a network interface, and outputs (sends) data to the outside in accordance with an instruction input by way of the control section 11. Moreover, the interface section 15 accepts (receives) the data input from the outside and outputs the thus-received data to the control section 11.

The image data which are to be an object of processing in the present embodiment may be, e.g., bitmap data (data in which pixel values (colors) are arranged for respective pixels) or data described in PDF (Portable Document Format), PDL (Page Description Language), or the like. The following descriptions are provided under an assumption that the image data are described in PDF.

Specifically, in accordance with the PDF, a character string included in image data and information used for generating a figure or a bitmap image are described objects, each including at least one drawing command. For instance, a line segment drawing command including coordinate values of both end points of a line segment is described as information to be used for generating an image element of a line segment. The PDF data are basically configured as a set of objects including such drawing commands.

Specific processing of the control section 11 is now described. The control section 11 receives designation of PDF data which are to be objects of processing. The PDF data which are objects of processing may be data generated by the control section 11 or data which have been generated outside and input by way of the interface section 15.

[Warning about Total Quantity of Ink]

In accordance with the drawing command sequence included in the PDF data, the control section 11 calculates estimated quantity of ink for each color used for printing an image expressed by the PDF data.

More specifically, this processing is performed by a method for calculating estimated quantity of ink from the drawing command sequence included in the PDF data by reference to a command for designating colors of an object (i.e., a color designation command), in accordance with the color designation command; or a method for subjecting PDF data to rendering to thus generate bitmap data and calculating estimated quantity of ink on the basis of values of pixels included in the bitmap data. The respective methods will be described hereunder.

When the command for designating the color of an object is used, the control section 11 operates as follows. Specifically, when having found a color designation command during the course of rendering the PDF data to be processed, the control section 11 converts colors designated by the command into values in a CMYK color space. Estimated quantity of ink for each color are calculated from values for each color CMYK. The only requirement herein is to take, as estimated quantity of ink, percentage values obtained by dividing the converted CMYK values by maximum values thereof. For example, given that the value of cyan (C) is 25 and the maximum value thereof is 255, a percentage value is determined by 25/255=0.098. . . . Hence, the estimated quantity of cyan ink is calculated as about 9.8%. The control section 11 calculates a total of the estimated quantity of ink for each color C, M, Y, and K.

The control section 11 determines whether or not the total (a total ink quantity) of calculated, estimated quantity of ink of colors has exceeded a predetermined quantity. If the total has not exceeded the predetermined quantity, drawing operation (rendering operation) using the thus-designated colors is continued. In contrast, when the total of calculated, estimated quantity of ink for each color has exceeded the predetermined quantity, the rendering operation is continued with use a predetermined warning color in lieu of the designated colors.

According to this method, a total of estimated quantity of ink is calculated on a predetermined drawing unit (e.g., an object in the PDF data) of the drawing command sequence, and a determination is made as to whether or not the total of estimated quantity of ink has exceeded the predetermined quantity of ink. In connection with the drawing unit whose total of estimated quantity of ink has exceeded the predetermined quantity, rendering operation is performed in a warning color in accordance with the drawing command in the drawing unit.

In connection with the drawing command sequence in the predetermined drawing unit whose total of estimated quantity of ink has not exceeded the predetermined quantity, a result of drawing based on the drawing command sequence is generated and output.

As a result, the location where the total quantity of ink has exceeded the predetermined quantity can be indicated on the image of the rendering result. According to this method, the area where the total quantity of ink has exceeded the predetermined quantity is drawn in the warning color, and the result of drawing is printed. As a result, when the print result is a drawing drawn in the warning color, the user can ascertain the necessity for modifying designation of colors in the drawing.

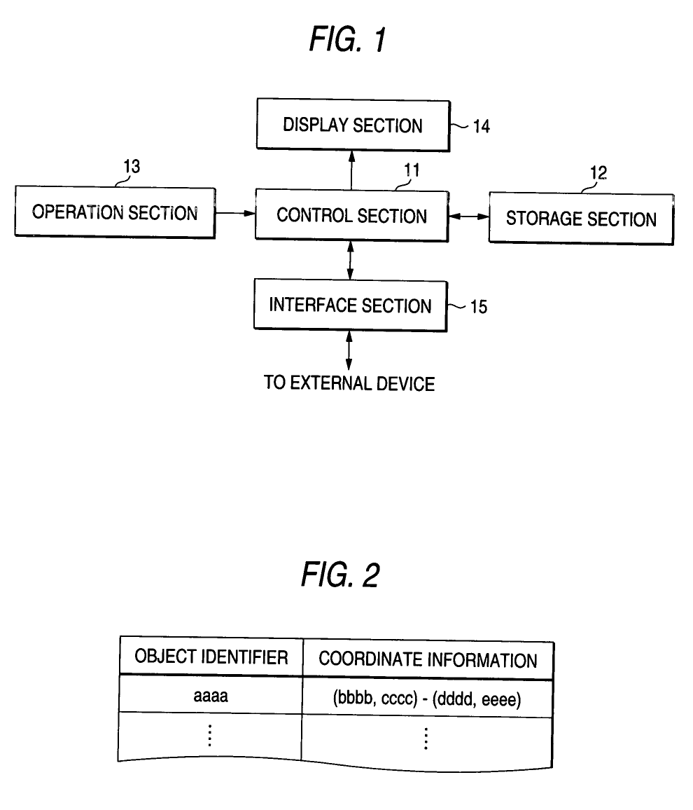

Next will be described a method for calculating estimated quantity of ink after rendering operation. In this case, the control section 11 first subjects PDF data to rendering on the basis of the PDF data to be processed, to thus generate bitmap data. At this time, the control section 11 generates, for each object, information used for defining areas drawn in accordance with the drawing commands included in the objects. Specifically, there is generated coordinate information for defining a minimum rectangle containing pixels whose values have been changed in accordance with the drawing command (i.e., a circumscribed rectangle surrounding pixels whose values have been changed in accordance with the drawing command). The coordinate information is stored as an area database in the storage section 12 in association with information for specifying objects (e.g., object numbers in the PDF) (FIG. 2).

Next, the control section 11 converts pixel values of the bitmap data obtained as a result of the rendering operation into pixel values in the CMYK color space. Estimated quantity of ink of colors are calculated from the values of respective CMYK colors. Even in this case, the only requirement is to take, as estimated quantity of ink, percentage values determined by dividing the CMYK values of respective pixels by maximum values thereof. The control section 11 calculates a total of the estimated values calculated for the respective colors C, M, Y, and K.

A total of estimated quantity of ink for each color is obtained for each pixel. The control section 11 ensures, as an ink quantity warning plane in the storage section 12, an area where there are stored bitmap image data formed from a group of pixels which are of the same size as the bitmap data generated by the rendering operation. Here, one-bit data of white or black is acceptable as a pixel in the ink quantity warning plane. The control section 11 has initialized the pixels included in this ink quantity warning plane as, e.g., white, in advance.

The control section 11 retrieves pixels whose total of estimated quantity of ink determined through the foregoing operations exceeds a predetermined quantity. If there is a pixel whose total of estimated quantity of ink has exceeded the predetermined quantity, the control section 11 sets the value of the pixel located at a position corresponding to the pixel to “black” on the ink quantity warning plane.

As a result, the area where the total quantity of ink has exceeded the predetermined value is taken as a bitmap pattern. The control section 11 displays an image included in the ink quantity warning plane on the display section 14. At this time, the image of the ink quantity warning plane may also be displayed while being translucently synthesized with an image resulting from rendering operation. Here, the translucent synthesis is realized by the following scheme. Specifically, through use of a pixel value P (x, y) at a position (x, y) in the image, which is the result of rendering, and a pixel value Q (x, y) of the image of the ink quantity warning plane corresponding to this pixel, a pixel value D (x, y) achieved at the time of display of the position (x, y) is expressed by
D(x, y)=λ×P(x, y)+(1−k)×Q(x, y).

Here, λ denotes a value in the range from 0 to 1 and represents the intensity of synthesis. As a result, a location where the total quantity of ink exceeds the predetermined value can be provided on the image of the rendering result.

Moreover, the control section 11 of the present embodiment may also report the nature of an object to which belongs the drawing instruction used for specifying the location as an object of a warning about the total quantity of ink. Specifically, the control section 11 specifies a block of pixels which are displayed in “black” on the ink quantity warning plane, thereby generating information about a circumscribed rectangle (a warning area) for each pixel block. A widely-known image processing technique can be used for processing for detecting a block of pixels or processing for generating information about the circumscribed rectangle. Hence, detailed explanations of the technique are omitted.

The control section 11 retrieves rectangle information containing at least a portion of the circumscribed rectangle of the warning area among the rectangle information items about respective objects included in the area database. There is specified an object associated with the rectangle information containing at least a portion of the circumscribed rectangle of the warning area. As mentioned above, potentially-relevant objects are narrowed down by means of a subsumptive relationship of the circumscribed rectangle, thereby lessening processing burden.

The control section 11 determines whether or not the value of a pixel whose the total quantity of ink exceeds a predetermined value is determined by the drawing command sequence included in the specified object. For instance, depending on a drawing command, the value of the pixel whose total quantity of ink exceeds the predetermined value is not changed, or the value of the pixel is overwritten by another subsequent drawing command even after the value of the pixel has been changed. In either case, the value of the pixel whose total quantity of ink has exceeded the predetermined value is determined not to be specified, by the drawing command sequence included in the specified object.

When the value of the pixel, whose total quantity of ink exceeds the predetermined value, is determined by the drawing command sequence included in the specified object, there is displayed the object or the information specifying the drawing command (i.e., the drawing command portion of the present invention) relevant to the value of the pixel. For instance, a contour of the object is preferably highlighted.

[Process Black Warning]

After having converted the image data that are the result of rendering into a CMYK value, the control section 11 compares estimated quantity of ink of respective components C, M, and Y of the CMYK value of each pixel. Information for specifying the pixels whose estimated quantity are essentially equal to each other is stored in the storage section 12. Specifically, even in this case, the control section 11 ensures, as a process black warning plane in the storage section 12, an area where are stored bitmap image data formed from a group of pixels which are of the same size as those of the bitmap data generated by rendering. Here, one-bit data of white or black is acceptable as a pixel in the process black warning plane. The control section 11 has initialized the pixels included in this process black warning plane as, e.g., white, in advance.

The control section 11 sets, to “black,” a pixel in the process black warning plane corresponding to the pixels whose quantity of ink are essentially equal to each other, by means of comparison of the quantity of ink. The estimated values are determined to be essentially equal to each other, by means of determining whether or not a difference between the maximum and minimum values of values to be compared is less than a predetermined threshold value.

As a result, the area expressed in process black is obtained as a pattern (image portion) of the bitmap. The control section 11 displays on the display section 14 an image included in the process black warning plane. Even in this case, an image of the process black warning plane may be displayed while being translucently synthesized with an image resulting from rendering operation.

As in the case of the warning about the total quantity of ink, the control section 11 of the present embodiment may also report the nature of an object to which belongs the drawing instruction used for representing the location in process black. Specifically, the control section 11 specifies a block of pixels which are displayed in “black” on the process black warning plane, thereby generating information about a circumscribed rectangle (called a second warning area for convenience) for each pixel block.

The control section 11 retrieves rectangle information containing at least a portion of the circumscribed rectangle of the second warning area among the rectangle information items about respective objects included in the area database. There is specified an object associated with the rectangle information containing at least a portion of the circumscribed rectangle of the second warning area.

The control section 11 determines whether or not values of pixels drawn in accordance with the drawing command sequence included in the specified object are essentially equal to the estimated quantity of ink determined from the respective C, M, and Y values. When the estimated quantity of ink obtained from the C, M, and Y values are essentially equal to each other for the values of respective pixels drawn in accordance with the drawing command sequence included in the specified object, the object or the information specifying the drawing instruction relevant to the values of the pixels (i.e., a so-called drawing command portion) is displayed. For instance, a contour of the object is preferably highlighted.

According to the present embodiment, the CMYK data are generated on the basis of the image data that have become objects of processing, and quantity of ink for each color corresponding to pixels are estimated from the CMYK data. Of the pixels, a pixel whose total of estimated quantity of ink (total ink quantity) exceeds a predetermined quantity and a drawing command pertaining to drawing of the pixel (an object or a drawing command) are offered. As a result, the user can ascertain in advance the area where the total quantity of ink may exceed the predetermined value.

In the present embodiment, in relation to the estimated quantity of ink of respective pixels, a pixel whose quantity of ink of respective components cyan (C), magenta (M), and yellow (Y) are essentially equal to each other and a drawing command pertaining to drawing of that pixel (an object or a drawing command) are offered. As a result, the user can ascertain an area to be expressed in process black (a so-called registration color area) in advance, and the quantity of ink required during printing can be reported.

The user adjusts contents of image data by reference to the nature of the report. The control section 11 may also subject image data to predetermined image processing (e.g., processing pertaining to UCR or GCR) in accordance with the nature of the report. One of the characteristics of the present embodiment is to report the total quantity of ink or an area to be represented in process black prior to color correction processing required at the time of output of image data to a printer. As a result, report processing conforming to circumstances of printing becomes possible.

As described above, according to an embodiment of the present invention, there is provided an image processing apparatus.

According to an embodiment of the present invention, there is provided an image processing apparatus. The image processing apparatus includes an operating section and a control section. The operating section operates a control section, and the operating section is operated by a user. The control section calculates estimated quantity of ink for each color used for printing an image expressed by image data and notifies a user of information that a total of the calculated estimated quantity of ink for each color exceeds predetermined quantity.

Here, the image data which is objects of processing include a drawing command sequence, and the control section may calculate estimated quantity of ink for each color used for printing an image expressed by the image data, based on the drawing command instruction. When the total of the calculated estimated quantity of ink for each color exceeds the predetermined quantity, information used for specifying a drawing command portion pertaining to the quantity of ink may further be reported.

The control section may further compare the calculated estimated quantity of ink for each color with each other. When there is an image portion where the calculated estimated quantity of ink for each color are of substantially the same as each other, information about the portion may further be reported.

The control section may calculate the estimated quantity of ink for each color, which is used for printing an image under a drawing command in a predetermined drawing unit, for each predetermined drawing unit in the drawing command sequence, and may determine whether or not the total of the estimated quantity of ink for each color calculated for each predetermined drawing unit exceeds the predetermined quantity. Then the control section may generate and output a result of drawing in accordance with the drawing command sequence as to the drawing command sequence in the predetermined drawing unit which does not exceed the predetermined quantity.

According to another embodiment of the present invention, there is provided an image processing method executed by a computer, the method includes calculating estimated quantity of ink for each color used for printing an image expressed by image data, based on the image data, and when a total of the calculated estimated quantity of ink for each color exceeds a predetermined quantity, notifying a report of this effect.

According to still another embodiment of the present invention, there is provided a program for causing a computer to perform calculating estimated quantity of ink for each color used for printing an image expressed by image data, based on the image data, and when a total of the calculated estimated quantity of ink for each color exceeds a predetermined quantity, notifying a report of this effect.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

What is claimed is:

1. An image processing apparatus comprising:
an operating section that operates a control section, the operating section being operated by a user; the control section that calculates estimated quantity of ink for each color used for printing an image expressed by image data and notifies a user of information that a total of the calculated estimated quantity of ink for each color exceeds predetermined quantity.

2. The image processing apparatus according to claim 1, wherein
the image data includes a drawing command sequence, and
the control section calculates the estimated quantity of ink for each color based on the drawing command instruction.

3. The image processing apparatus according to claim 2, wherein the control section further notifies information for specifying a drawing command portion, which corresponds to an image portion where the total of the calculated estimated quantity of ink for each color exceeds the predetermined quantity.

4. The image processing apparatus according to claim 1, wherein the control section compares the calculated estimated quantity of ink for each color with each other, and when there is an image portion where the calculated estimated quantity of ink for each color are of substantially the same as each other, the control section further notifies information about the image portion.

5. The image processing apparatus according to claim 2, wherein
the control section calculates the estimated quantity of ink for each color in a drawing unit in the drawing command sequence.

6. The image processing apparatus according to claim 5, wherein an image processing of the drawing unit is processed based on the drawing command sequence when the total of the estimated quantity in the drawing unit dose not exceed the predetermined quantity.

7. The image processing apparatus according to claim 5, wherein when the total of the estimated quantity in the drawing unit exceeds the predetermined quantity, the image processing of the drawing unit is processed using a predetermined warning color.

8. The image processing apparatus according to claim 5, wherein when the total of the estimated quantity in the drawing unit exceeds the predetermined quantity, the image processing of the drawing unit is processed and displayed an output translucently.

9. An image processing method comprising:
calculating estimated quantity of ink for each color used for printing an image expressed by image data; and
notifying a user of information that a total of the calculated estimated quantity of ink for each color exceeds predetermined quantity.

10. The image processing method according to claim 9, wherein the image data includes a drawing command sequence, and a process of calculating the estimated quantity is processed based on the drawing command instruction.

11. The image processing method according to claim 10, wherein a process of notifying is processed to notify information for specifying a drawing command portion, which corresponds to an image portion where the total of the calculated estimated quantity of ink for each color exceeds the predetermined quantity.

12. The image processing method according to claim 9, further comprising:
comparing the calculated estimated quantity of ink for each color with each other, and wherein when there is an image portion where the calculated estimated quantity of ink for each color are of substantially the same as each other, the process of notifying is processed to notify information about the image portion.

13. The image processing method according to claim 10, wherein the process of calculating is processed to calculate the estimated quantity of ink for each color in a drawing unit in the drawing command sequence.

14. The image processing method according to claim 13, wherein an image processing of the drawing unit is processed based on the drawing command sequence when the total of the estimated quantity in the drawing unit dose not exceed the predetermined quantity.

15. The image processing method according to claim 13, wherein when the total of the estimated quantity in the drawing unit exceeds the predetermined quantity, the image processing of the drawing unit is processed using a predetermined warning color.

16. The image processing method according to claim 13, wherein when the total of the estimated quantity in the drawing unit exceeds the predetermined quantity, the image processing of the drawing unit is processed and displayed an output translucently.

17. A storage medium readable by a computer, the storage medium storing a program of instructions executable by the computer to perform a function for processing an image, the function comprising:
calculating estimated quantity of ink for each color used for printing an image expressed by image data; and
notifying a user of information that a total of the calculated estimated quantity of ink for each color exceeds predetermined quantity.

18. The storage medium according to claim 17, wherein the image data includes a drawing command sequence, and a process of calculating the estimated quantity is processed based on the drawing command instruction.

19. The storage medium according to claim 17, wherein a process of notifying is processed to notify information for specifying a drawing command portion, which corresponds to an image portion where the total of the calculated estimated quantity of ink for each color exceeds the predetermined quantity.

20. The storage medium according to claim 17, further comprising:
comparing the calculated estimated quantity of ink for each color with each other, and wherein when there is an image portion where the calculated estimated quantity of ink for each color are of substantially the same as each other, the process of notifying is processed to notify information about the image portion.
